(19) United States
(12) Patent Application Publication
(10) Pub. No.: US 2011/0201221 A1
(43) Pub. Date: Aug. 18, 2011

(54) IC SOCKET

(76) Inventor: Masahiko Kobayashi, Kanagawa (JP)

(21) Appl. No.: 13/124,156

(22) PCT Filed: Oct. 5, 2009
(86) PCT No.: PCT/US2009/059489

§ 371 Date: Apr. 14, 2011

(30) Foreign Application Priority Data
Oct. 17, 2008 (JP) 2008-268986

(51) Int. Cl. H01R 13/62

(52) U.S. Cl. 439/331

(57) ABSTRACT

An IC socket includes a housing detachably containing an IC device, a plurality of contacts provided respectively with contact points disposed inside the housing in an elastically displaceable manner, a pressing member pressing the IC device contained and making the leads of the device abut against the contact points of the contacts, an elastic member elastically biasing the pressing member and making the pressing member generate a pressing force for pressing the IC device, and an operation member adapted to be operated to move relative to the housing against the biasing force of the elastic member so as to displace the pressing member. A force transmission member is interposed between the elastic member and the operation member, for transmitting the biasing force of the elastic member to the operation member with the biasing force being reduced by a leverage action.

### TECHNICAL FIELD

The present invention relates to an IC socket that releasably supports an IC (Integrated Circuit) device.

### BACKGROUND

An IC socket is used as a kind of mounting connector that releasably supports an IC device in an electronic circuit for which replacement, addition and/or deletion of IC devices is expected. The IC socket electrically connects the IC device to the electronic circuit via a plurality of contacts incorporated therein. An IC socket used for testing when electrical tests such as conduction test, etc., are to be conducted on an IC device before being mounted to an electronic apparatus is also well known to those skilled in the art.

For example, Japanese Unexamined Patent Publication (Kokai) No. 2005-327628 describes an IC socket comprising a housing having a supporting part for supporting an IC device, a plurality of contacts with respective contact points disposed in the supporting part so as to permit elastic displacement, a pressing member for pressing an IC device supported on the supporting part so as to cause a plurality of leads of the IC device to abut against the contact points of the plurality of contacts, a biasing mechanism for producing a pressing force to press the IC device against the pressing member, and an operation member for performing open/close operation of the pressing member on the housing to displace the pressing surface. The pressing member comprises a spindle which is guided on the housing in linear movement, and a pressing surface which can be displaced in a rocking manner on the housing with the spindle as the center. The biasing mechanism causes the pressing surface to produce a pressing force by applying a biasing force to the spindle of the pressing member. The biasing mechanism comprises an elastic member for elastically biasing the operation member in the direction away from the housing, and a lever for transmitting the force applied by the elastic member to the operation member as a biasing force to the spindle. With such construction, the elastic biasing force of the elastic member can be amplified by the booster function imparted to the lever, and can be transmitted to the spindle of the pressing member.

Japanese Unexamined Patent Publication (Kokai) No. 2007-311169 describes an IC socket comprising a socket body having a housing for housing an IC package, a plurality of contact pins disposed in the socket body for conductively coming in contact with the terminals of the IC package, a pressing member for pressing the IC package housed in the socket body, an operation member disposed in the socket body so as to permit up-and-down movement for rotating the pressing member, and a plurality of springs disposed between the socket body and the operation member for biasing the operation member to the upper-limit position. The operation member is provided with an activating part for pressing and rotating an activated part fitted at a base end side of the pressing member. The socket body has a support member disposed so as to permit up-and-down movement, the pressing member being rotatably supported by the support member. The support member is interconnected to the operation member via a link member. As the operation member is lowered, the support member is raised via the link member, while the pressing member is rotated to be opened by the cooperation of the activating part and the activated part. At the time of raising the operation member, the pressing member is rotated to be closed in generally horizontal position by the cooperation of the activating part and the activated part, while the support member is lowered via the link member, so that the pressing member is caused to translate downward so as to press the IC package.

### SUMMARY

Each of the conventional IC sockets described above is constructed such that the biasing force of the elastic member or springs for biasing the operation member upward is amplified by a lever or a link, and is then transmitted to the pressing member so as to produce required pressing force while reducing the operating force of the operation member (that is, the force for displacing the pressing member from the closed position to the open position). In such construction, the transmission loss of the force such as frictional loss in the moving part of the lever or the link, etc., has to be taken into account in order to set the biasing force of the elastic member.

It is an object of the present invention to provide an IC socket comprising a pressing member for pressing an IC device to a plurality of contacts, which is capable of reducing transmission loss of the biasing force of an elastic member for producing the pressing force in the pressing member, and of displacing the pressing member with small operating force.

In order to accomplish the above object, one aspect of the invention provides an IC socket comprising a housing detachably containing an IC device; a plurality of contacts provided respectively with contact points disposed inside the housing in an elastically displaceable manner; a pressing member pressing the IC device contained in the housing and making a plurality of leads of the IC device abut against the contact points of the plurality of contacts; an elastic member elastically biasing the pressing member and making the pressing member generate a pressing force for pressing the IC device; and an operation member adapted to be moved relative to the housing against the biasing force of the elastic member and to displace the pressing member between a closed position for generating the pressing force and an open position spaced from the closed position; characterized in that the IC socket comprises a force transmission member interposed between the elastic member and the operation member, the force transmission member transmitting the biasing force of the elastic member to the operation member with the biasing force being reduced by a leverage action; and that the pressing member is adapted to accompany a movement of the operation member relative to the housing under an operating force corresponding to the biasing force of the elastic member reduced by the force transmission member, and thus to be displaced between the closed position and the open position.

An IC socket according to one aspect of the present invention has the construction in which the biasing force of the elastic member is transmitted to the pressing member to produce the pressing force without being mediated by a force amplifying mechanism such as a lever or a link as in conventional structure while the operating force required to operate the operation member is reduced by the leverage action of the force transmission member. Therefore, the transmission loss of the biasing force of the elastic member for producing the pressing force of the pressing member can be reduced, and the pressing member can be displaced to be opened or closed by a small operating force.

### BRIEF DESCRIPTION OF THE DRAWINGS

FIG. 1 An exploded perspective view showing an IC socket according to an embodiment of the present invention.

FIG. 2 An assembled perspective view showing the IC socket of FIG. 1 in the state with the operation member in the lower-limit position.

FIG. 3 An assembled perspective view showing the IC socket of FIG. 1 in the state with the operation member in the upper-limit position.

FIG. 4 An assembled plan view showing the IC socket of FIG. 1 in the state with the pressing member in the closed position.

FIG. 5 A perspective view showing the essential part of the IC socket of FIG. 1 in the state with the pressing member in the closed position.

FIG. 6 A sectional view taken along the line VI-VI of FIG. 4.

FIG. 7 A sectional view taken along the line VII-VII of FIG. 4.

FIG. 8 A sectional view corresponding to FIG. 6 showing the state with the pressing member in the intermediate position.

FIG. 9 A sectional view corresponding to FIG. 7 showing the state with the pressing member in the intermediate position.

FIG. 10 A sectional view corresponding to FIG. 6 showing the state with the pressing member in the open position.

FIG. 11 A sectional view corresponding to FIG. 7 showing the state with the pressing member in the open position.

FIG. 12 A schematic view showing the essential part of the IC socket of FIG. 1 useful for explaining the operation thereof, (a) in the state with the pressing member in the closed position; and (b) in the state with the pressing member in the open position.

### DETAILED DESCRIPTION

Now, the present invention will be described in detail below with reference to appended drawings showing embodiments thereof. Throughout the drawings, corresponding constituents are denoted by common reference numerals or symbols.

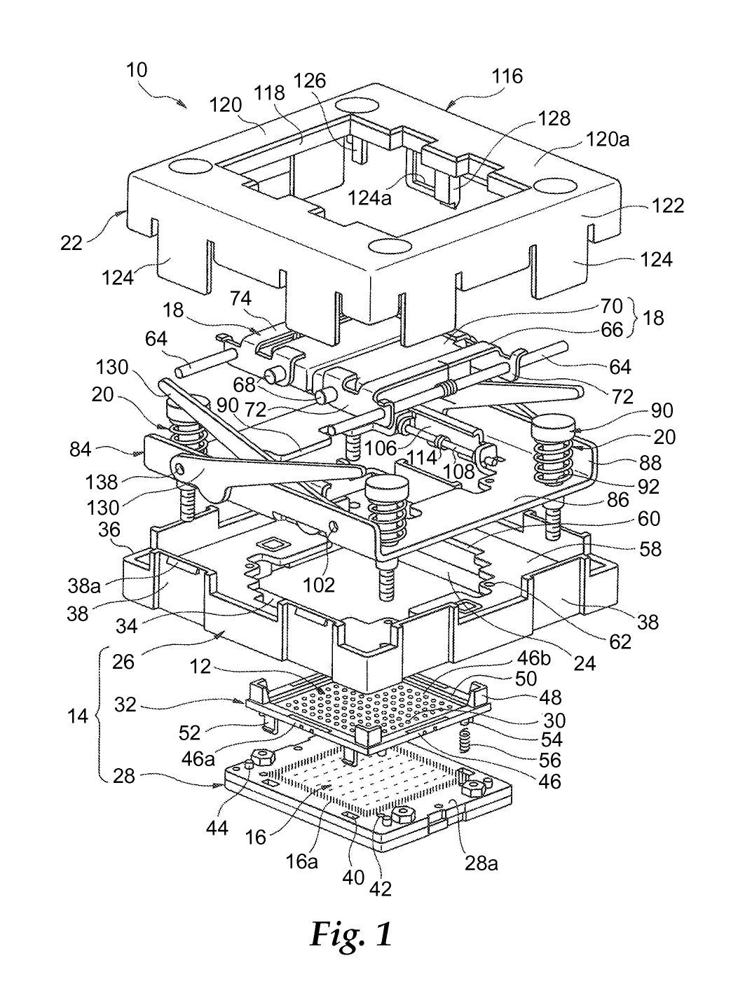

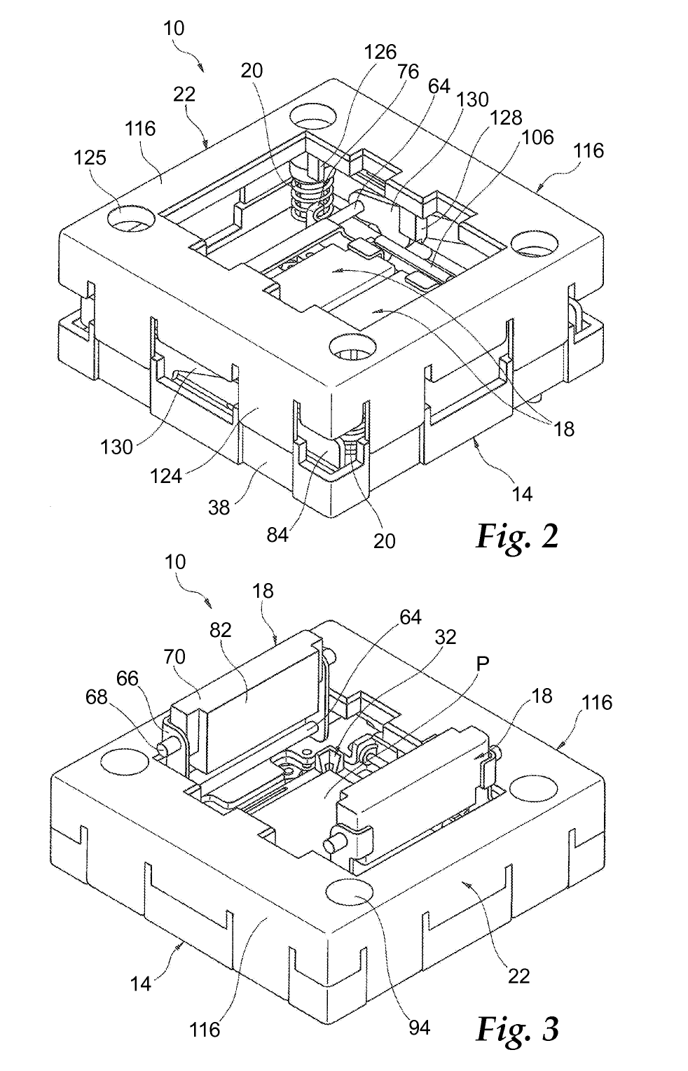

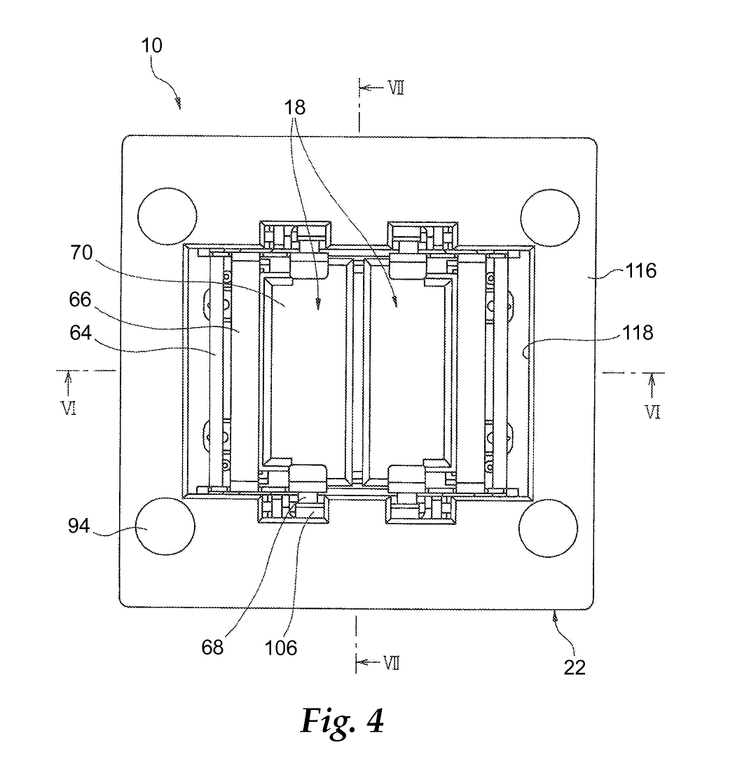

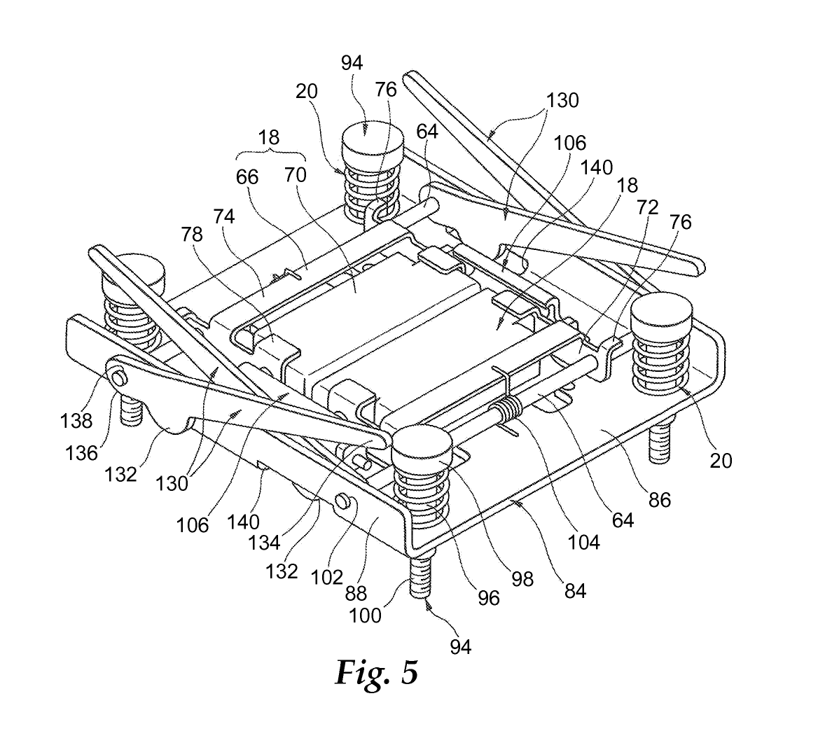

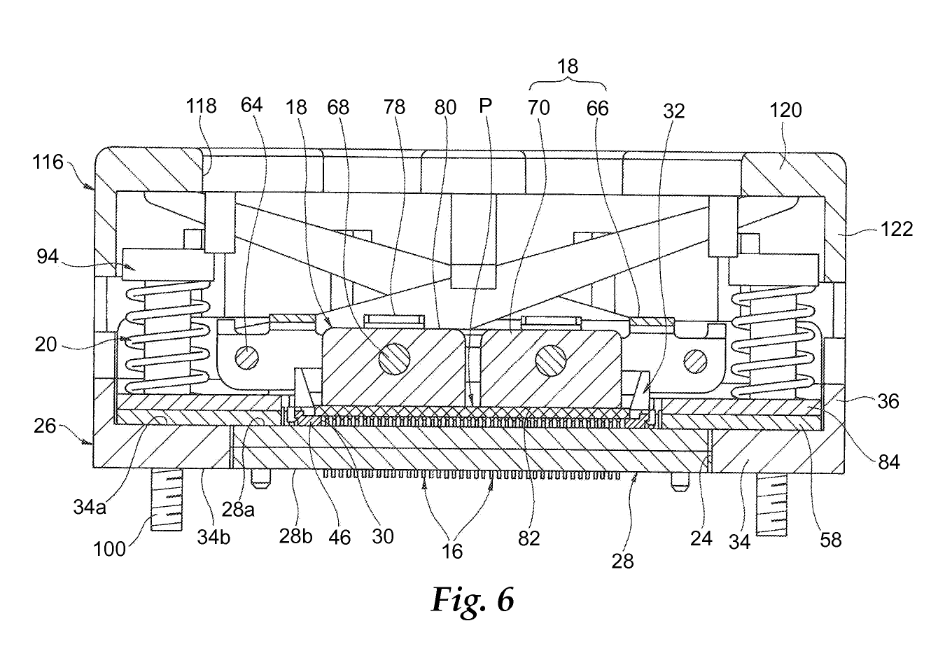

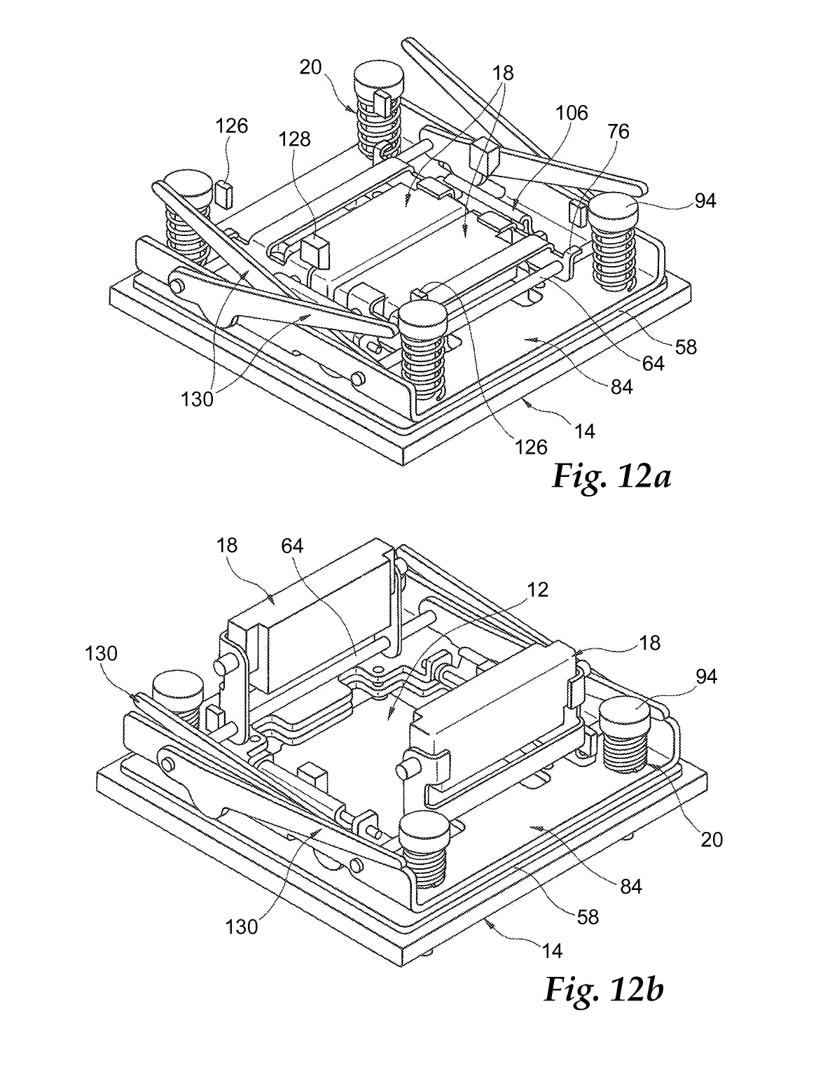

FIG. 1 is an exploded perspective view showing essential parts of an IC socket 10 according to an embodiment of the present invention. FIG. 2 and FIG. 3 are perspective views showing the IC socket 10 in different operating states, FIG. 4 is a plan view showing the IC socket 10 in one operating state, FIG. 5 is an enlarged perspective view showing the essential part of the IC socket 10, FIG. 6-FIG. 11 are sectional views showing the IC socket 10 in different operating states, and FIG. 12 is a schematic view of essential part of the IC socket 10 useful for explaining the operation. The IC socket 10 shown can be used for an IC device having an array type package structure having a large number of leads (that is, electrode pads) arranged in a rectangular grid or zigzag grid (for example, a BGA (ball grid array) or LGA (land grid array)), but the applications of the present invention are not limited to this.

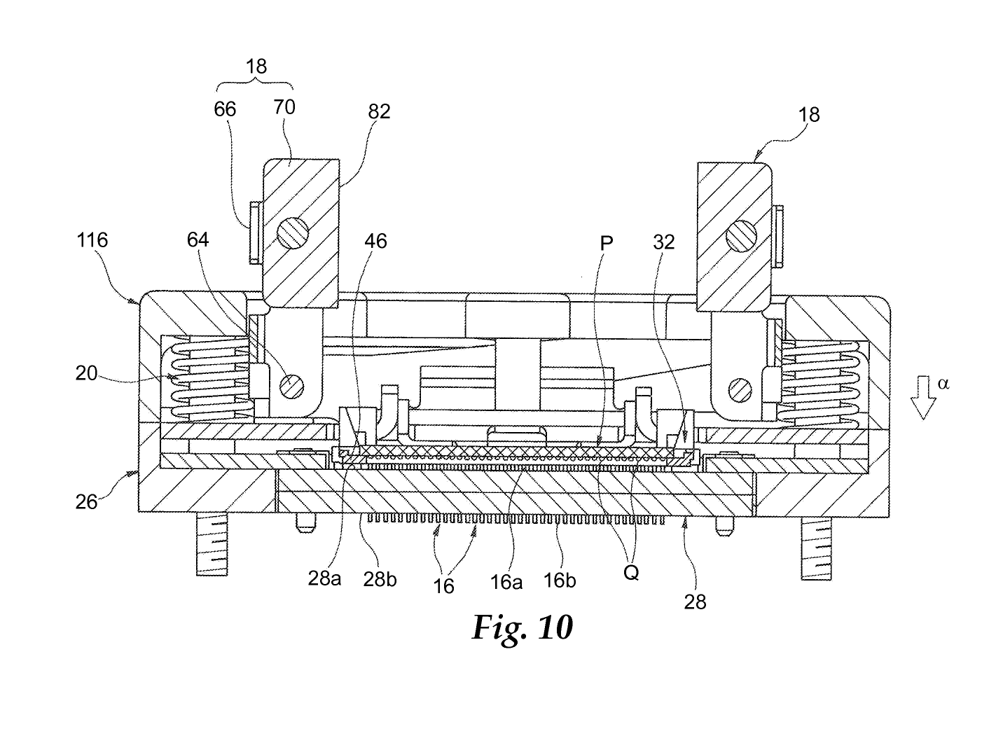

As shown in FIG. 1, the IC socket 10 is provided with a housing 14 having a space 12 for detachably containing an IC device P (FIG. 3), a plurality of contacts 16 with respective contact points 16a disposed inside the housing 14 adjacent to the space 12 so as to permit elastic displacement, a pressing member 18 for pressing the IC device P contained in the space 12 so as to cause the plurality of leads Q (FIG. 10) of the IC device P to abut against the contact points 16a of the corresponding contacts 16, an elastic member 20 for elastically biasing the pressing member 18 to produce a pressing force for pressing the IC device P to the pressing member 18, and an operation mechanism 22 to be moved relative to the housing 14 against the biasing force of the elastic member 20 for displacing the pressing member 18.

The housing 14 is composed of an outer shell member 26 which has the shape of a generally rectangular frame when seen in plan view and has a center opening 24, a contact holding member 28 which has the shape of generally rectangular plate when seen in plan view and is disposed in the center opening 24 of the outer shell member 26 for holding a plurality of contacts 16 in a predetermined array pattern, and a support guide member 32 which has the shape of generally rectangular plate when seen in plan view and is attached to the contact holding member 28 and has a plurality of through-holes 30.

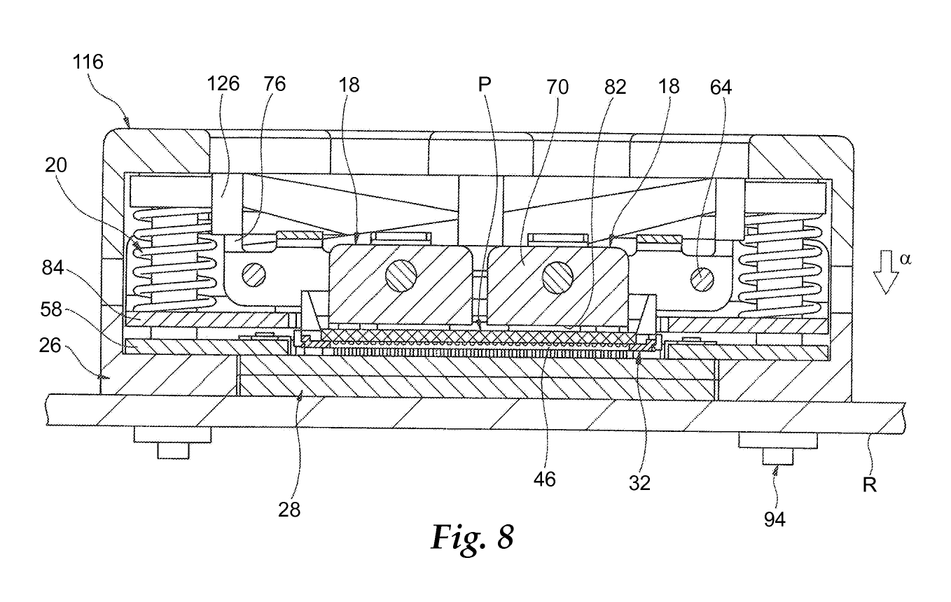

The outer shell member 26 is fabricated from an electrically insulating resin material superior in mechanical strength and heat resistance, and integrally comprises a bottom wall 34 having a center opening 24 and a circumferential wall 36 erected along the outer edge of the bottom wall 34 (FIG. 6). The bottom wall 34 of the outer shell member 26 has a substantially flat upper surface 34a and substantially flat back surface 34b opposed to the upper surface 34a (FIG. 6), the back surface 34b being disposed in contact with a circuit board R (FIG. 8) for mounting the IC socket 10. The circumferential wall 36 of the outer shell member 26 is provided on the outer surface with a plurality of grooves 38 extending in vertical direction generally perpendicular to the upper surface 34a and the lower surface 34b of the bottom wall 34 in suitably dispersed fashion.

The contact holding member 28 is fabricated from an electrically insulating resin material superior in mechanical strength and heat resistance, and has a substantially flat upper surface 28a and substantially flat back surface 28b opposed to the upper surface 28a (FIG. 6), and is disposed with the back surface 28b in contact with the circuit board R (FIG. 8) for mounting the IC socket 10. The contact holding member 28 has a plurality of through-holes (not shown) formed between the upper surface 28a and the back surface 28b for individually receiving a plurality of contacts 16. These through-holes are arranged in a rectangular grid array corresponding to the arrangement of the leads of the IC device P having an array type package structure, holding the plurality of contacts 16 in the same pitch as the lead pitch of the IC device P concerned.

Also on the upper surface 28a of the contact holding member 28, there are provided a plurality of locking holes 40 and spring receiving holes 42 for attaching a support guide member 32 to the contact holding member 28, and a plurality of protrusions 44 for positioning the contact holding member 28 relative to the outer shell member 26, respectively at predetermined positions (FIG. 1). The contact holding member 28 is detachably mounted to the center opening 24 of the outer shell member 26 with the upper surface 28a disposed on a virtual plane common to the upper surface 34a of the bottom wall 34 of the outer shell member 26, and with the back surface 28b disposed on a virtual plane common to the back surface 34b of the bottom wall 34 of the outer shell member 26 (FIG. 6).

The support guide member 32 is fabricated from an electrically insulating resin material superior in mechanical strength and heat resistance, and comprises a positioning support part 46 having a plurality of through-holes 30, and a guide part 48 locally erected at the four corners of the positioning support part 46 (FIG. 1). The positioning support part 46 of the support guide member 32 comprises a thick wall frame portion 46a extending along the outer edge, and a thin wall perforated plate portion inside the frame portion 46a. The plurality of through-holes 30 are formed in the perforated plate portion 46b in the rectangular grid array corresponding to the arrangement of the leads of the IC device P having an array type package structure in the same manner as the plurality of through-holes of the contact holding member 28.

The support guide member 32 receives the outer edge of the IC device P without looseness along the step difference formed between the frame portion 46a and the perforated plate portion 46b of the positioning support part 46, and individually receives the leads Q of the IC device P in the plurality of through-holes 30 in the perforated plate portion 46b to thereby support the IC device P at a predetermined position. The guide part 48 of the support guide member 32 acts, when the IC device P is attached to the positioning support part 46, to come into sliding contact with the four corners of the IC device and guide the IC device to a predetermined position.

A plurality of locking protrusions 52 and spring receiving protrusions 54 are formed on the back surface of the frame portion 46a of the positioning support part 46 of the support guide member 32 for attaching the support guide member 32 to the contact holding member 28 (FIG. 1). The support guide member 32 is detachably attached at a predetermined position to the upper surface 28a of the contact holding member 28 by inserting the locking protrusions 52 and spring receiving protrusions 54 into the corresponding locking holes 40 and the spring receiving holes 42 provided on the contact holding member 28. Here, an elastic element 56 such as a compression spring is disposed between the spring receiving holes 42 of the contact holding member 28 and the spring receiving protrusions 54 of the support guide member 32 for biasing the support guide member 32 upward away from the upper surface 28a of the contact holding member 28 (FIG. 1). The support guide member 32 can be moved in the direction toward and away from the upper surface 28a of the contact holding member 28 under the elastic biasing force of the elastic element 56 in the range of the locking protrusion 52 being under the drop-out preventing action in the locking hole 40 of the contact holding member 28.

Each of the plurality of contacts 16 is a pin-shaped conductor formed of material with good electrical conductivity and is provided with a contact point 16a at one end sticking out from the upper surface 28a of the contact holding member 28, a tail part 16b at the other end sticking out from the back surface 28b of the contact holding member 28 (FIG. 10). Each contact 16 is constructed with an elastic element (not shown) such as a compression coil spring interposed between a portion containing the contact point 16a and a portion containing the tail part 16b, and is held in the through-hole of the contact holding member 28 with the contact point 16a and the tail part 16b capable of being elastically displaced in the direction toward and away from each other.

The space 12 of the housing 14 is defined on the positioning support part 46 of the support guide member 32 with the contact holding member 28 and the support guide member 32 combined in proper positional relation. When the support guide member 32 is properly attached to the upper surface 28a of the contact holding member 28, the contact points 16a of a plurality of contacts 16 are all arranged at positions capable of being individually received in a plurality of through-holes 30 of the positioning support part 46 of the support guide member 32 (FIG. 10). By properly assembling the contact holding member 28 having support guide member 32 attached thereto into the center opening 24 of the outer shell member 26, the contact points 16a of a plurality of contacts 16 are arranged adjacent to the space 12 of the housing 14.

In this state, when the IC device P is properly placed on the perforated plate portion 46b of the positioning support part 46 of the support guide member 32, a plurality of leads Q of the IC device P are arranged in direct opposition to the contact points 16a of a plurality of contacts 16 in a plurality of through-holes 30 at positions capable of individually abutting to them (FIG. 10). At the time of using the IC socket 10, each of the contacts 16 is made to abut against and be conductively connected to the lead Q of the IC device P at the contact point 16a using the biasing force of the elastic element of its own as contact pressure, and is conductively connected to the test circuit etc. of a circuit board (FIG. 8) by the tail parts 16b.

It is advantageous that, as has been described above, the contact holding member be constructed detachably relative to the center opening 24 of the outer shell member 26. With this construction, it is possible to prepare a plurality of types of contact holding member 28 with different arrays of contacts 16 beforehand, and suitably select and switch to a contact holding member 28 of a contact array corresponding to the lead array of the IC device P of interest. Similarly, it is advantageous that the support guide member 32 be constructed detachably relative to the contact holding member 28. With this construction, it is possible to prepare a plurality of types of support guide members 32 with different arrays of holes and frame dimensions of the positioning support parts 46 beforehand, and suitably select and switch to a support guide member 32 of outer dimensions and the lead array corresponding to the IC device P concerned. It is also possible to construct the perforated plate portion 46b of the support guide member 32 detachably relative to the frame portion 46a, or to eliminate the region having through-holes of the perforated plate portion 46b to make a larger opening.

In the construction as described above, the outer shell member 26 may comprise a reinforcing member 58 for surface protection on the upper surface 34a of the bottom wall 34 thereof (FIG. 1). The reinforcing member 58 may be, for example, a plate member formed by punching a sheet metal material in a predetermined shape, which has a center opening corresponding to the center opening 24 of the outer shell member 26, and is fixed to an upper surface 34a of the bottom wall 34 at a predetermined position. With this construction, the reinforcing member 58 may be provided with an extension portion projecting inside the center opening 24 of the outer shell member 26, and a plurality of positioning holes 62 may be formed on this extension portion for individually receiving a plurality of protrusions 44 formed on the upper surface 28a of the contact holding member 28. In this manner, the contact holding member 28 can be accurately positioned and mounted to the outer shell member 26 at a predetermined position. Surface protection provided by the reinforcing member 58 will be described later. The reinforcing member 58 may be omitted if the upper surface 34a of the bottom wall 34 of the outer shell member 26 has sufficient strength.

The IC socket 10 comprises a pair of pressing members 18 respectively provided rotatably about the spindle 64 relative to the housing 14 (FIG. 1). Each pressing member 18 is constructed from a frame element 66 attached to the spindle 64 and a pressing element 70 carried in a rocking manner by the frame element 66 via a shaft 68. The frame element 66 may be formed, for example, by punching and bending a sheet metal material in a predetermined shape, and may have a pair of arm portions 72 extending in parallel to each other and a link portion 74 interconnecting the arm portions 72 to each other as one unit. The arm portions 72 are attached to the spindle 64 at respective one ends, and carry the pressing element 70 via the shaft 68 at respective other ends.

The frame element 66 has abutting pieces 76 sticking out in the direction away from each other generally in parallel to the spindle 64 respectively provided at one end edges of both arm portions 72 adjacent to the shaft 68 (FIG. 5). The function of the abutting pieces will be described later. The frame element 66 has also restricting pieces 78 sticking out in mutually approaching direction generally in parallel to the shaft 68 respectively provided at the other end edges of both arm portions 72 adjacent to the shaft 68 (FIG. 5). The restricting piece 78 acts so as to restrict the rocking movement of the pressing element 70 relative to the frame element 66.

The pressing element 70 of the pressing member 18 is a block body fabricated from an electrically insulating resin material of superior mechanical strength and heat resistance, with the shaft 68 fixed along the long axis of generally rectangular outline of the pressing element 70 and projecting from both longitudinal end faces of the pressing element 70. The pressing element 70 is attached to both arm portions 72 of the frame element 66 at the projecting portion of the shaft 68 so as to permit rocking movement. The pressing element 70 has an upper surface 80 as an outer surface of generally rectangular outline in opposition via a gap to a pair of restricting pieces 78 of the frame element 66, and a flat pressing surface 82 situated on opposite side of the upper surface 80 for pressing the IC device P (FIG. 6). The pressing element 70 can rock slightly relative to the frame element 66 with the rotated position in which the upper surface 80 comes in contact with both side edges of the restricting pieces 78 of the frame element 66 as a limiting point.

The IC socket 10 further comprises a movable base 84 attached to the housing 14 so as to permit linear movement and carrying rotatably the pressing member 18 (FIG. 1, FIG. 5). The movable base 84 may be formed, for example, by punching and bending a sheet metal material in a predetermined shape, and comprises a bottom plate portion 86 in the shape of generally rectangular frame when seen in plan view, and a pair of side plate portions 88 erected along a pair of outer edges of the bottom plate portion 86 as one integral unit. The movable base 84 is disposed on the reinforcing member 58 fixed to the outer shell member 26 of the housing 14, inside the circumferential wall 36 of the outer shell member 26.

In the bottom plate portion 86 of the movable base 84, a center opening 90 corresponding to the center opening 60 of the reinforcing member 58, and four through-holes 92 situated near four corners of the center opening 90, are formed. In these through-holes 92, four guide pins 94 for attaching the movable base 84 to the housing 14 are disposed and individually inserted slidably. Unshown through-holes are formed in the bottom wall 34 and the reinforcing member 58 of the outer shell 26 of the housing 14 at positions corresponding to the plurality of through-holes 92 of the movable base 84.

Each guide pin 94 comprises a guide axis part 96 slidably inserted in the through-hole 92 of the movable base 84, a head part 98 projecting radially outward at one end of the guide axis part 96, and a screw part 100 formed at the other end of the guide axis part 96 (FIG. 5). The guide pin 94 is inserted into the through-hole 92 from above the movable base disposed on the outer shell member 26 of the housing 14 with the screw part 100 pointing forward, and further into the corresponding through-hole (not shown) formed in the reinforcing member 58 and bottom wall 34 of the outer shell member 26. Then, on the side of the back surface 34b of the bottom wall 34 of the outer shell member 26, an unshown nut is threadedly attached to the screw part 100 of the guide pin 94 to thereby fix the guide pin 94 to the housing 14 at a predetermined position.

Four guide pins 94 fixed to the housing 14 guide the movable base 84 with their guide axis parts 96 in linear movement relative to the housing 14. Therefore, the movable base 84 can move in translation along four guide pins 94 on the housing 14 in vertical direction perpendicular to the upper surface 34a while maintaining the bottom plate portion 86 in parallel to the reinforcing member 58 and the upper surface 34a (FIG. 6) of the bottom wall 34 of the outer shell member 26. The guide pins 94 can also function as bolts for attaching the IC socket 10 to a circuit board R.

In both side plate portions 88 of the movable base 84, four bearing holes 102 in total are formed to penetrate at positions near the guide pins 94 (only one is shown in FIG. 1). Each of a pair of bearing holes 102 formed in one side plate portion 88 and each of a pair of bearing holes 102 formed in the other side plate portion 88 are arranged at positions opposed to and in coaxial alignment to each other. By a set of bearing holes 102 at opposed position of both side plate portions 88, the spindle 64 of one pressing member 18 is supported rotatably at both ends (FIG. 5). Thus, a pair of pressing members 18 are rotatably attached to the movable base 84 with respective spindles 64 arranged in parallel to each other and in parallel to the bottom plate portion 86 of the movable base 84. Thus, by attaching the movable base 84 to the housing 14 as described above, a pair of pressing members 18 can be rotated about the spindles 64 relative to the housing 14, and can move in vertical direction relative to the housing 14 with translation of the movable base 84 along the guide pins 94.

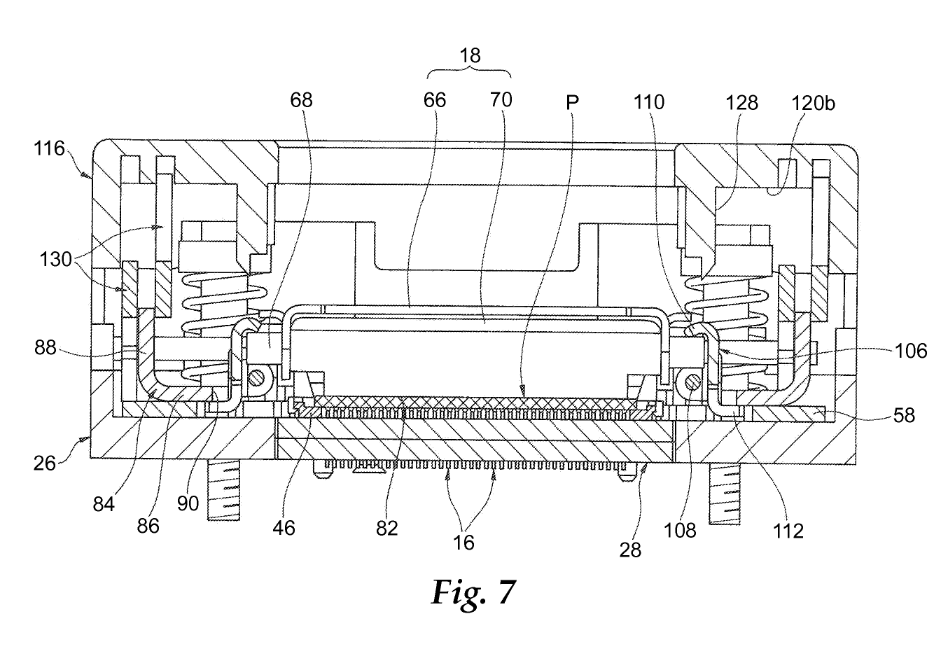

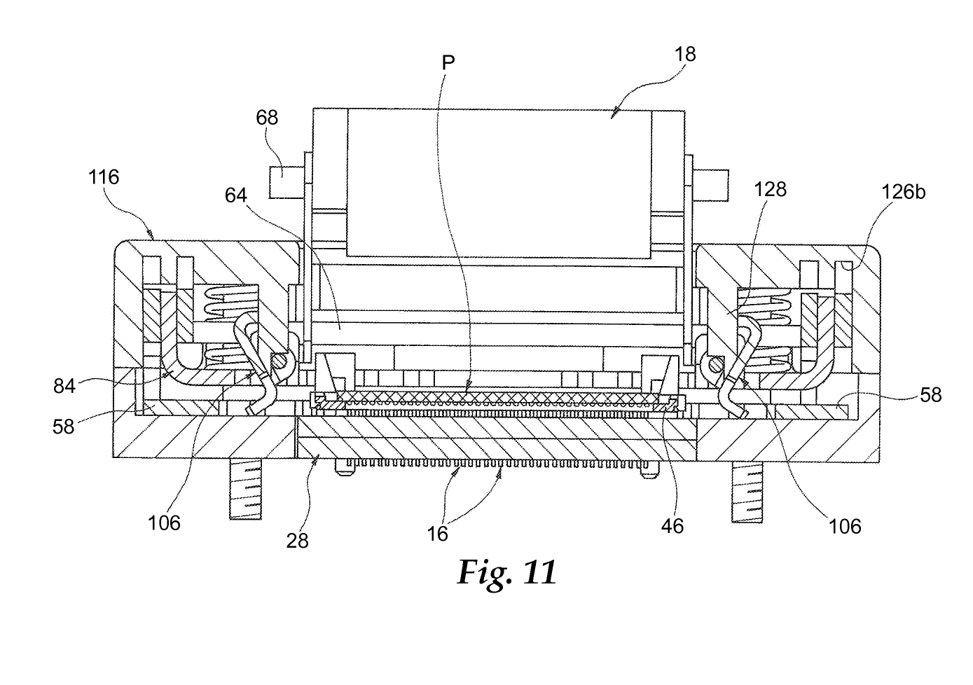

With the movable base 84 properly attached to the housing 14, the spindle 64 of each pressing member 18 is disposed in parallel to the back surface 34b of the bottom wall 34 of the outer shell member 26 of the housing 14. In this state, each pressing member 18 can rotate about the spindle 64 between a closed position in which the pressing surface 82 of the pressing element 70 comes in close opposition to the positioning support part 46 of the support guide member 32 (FIG. 6, FIG. 7) and an open position in which the pressing surface 82 of the pressing element 70 is spaced from the positioning support 46 of the support guide member 32 (FIG. 10, FIG. 11). When in closed position, each pressing member 18 can apply required pressing force to the IC device P placed on the positioning support part 46 of the support guide member 32 with the pressing surface 82 of the pressing element 70.

When in closed position, a pair of pressing members 18 are arranged most closely in parallel to each other with the shafts 68 of respective pressing elements in parallel, and respective pressing surfaces 82 can be arranged on a virtual plane common to both (FIG. 6). When in open position, a pair of pressing members 18 are arranged most spaced from each other with the shafts 68 of respective pressing elements in parallel, and respective pressing surfaces 82 can be arranged substantially in opposition to each other (FIG. 10). An elastic element 104 such as a helical torsion coil spring is attached to the spindle 64 of each pressing member 18 for elastically biasing the pressing member 18 toward the closed position (FIG. 5). Biasing force of the elastic element 104 is sufficiently smaller than the biasing force of the elastic member 20 that causes the pressing member 18 to produce the pressing force for pressing the IC device P.

The IC socket 10 comprises four elastic members 20 in total for causing the pressing member 18 to produce the pressing force required for pressing the IC device P. These elastic members 20 are individually arranged in a predetermined compression state between the head parts 98 of four guide pins 94 inserted into the through-holes 92 of the movable base 84 and the bottom plate portion 86 of the movable base 84 (FIG. 5). Each elastic member 20 consists of a compression coil spring capable of producing spring load of a few kg or a few tens of kg, and is disposed so as to surround the guide axis part 96 of each guide pin 94 fixed to the housing 12. When the guide pin 94 is regarded as integral with the hosing 12 as one unit, each elastic member 20 is disposed between the housing 12 and the movable base 84.

In the state with individual guide pins 94 properly fixed to the housing 12, each of the four elastic members 20 is compressed between the head part 98 of the guide pin 94 and the bottom plate portion 86 of the movable base 84 to generate required spring load. By the spring load of these elastic members 20, the movable base 84 is urged in the direction toward the housing 14 so that the bottom plate portion 86 of the movable base 84 comes in close contact under pressure with the reinforcing member 58 fixed to the outer shell member 26 of the housing 14. At this time, the spindles 64 of a pair of pressing members 18 attached to the movable base 84 are subjected to the same biasing force by the spring load of the elastic member 20, but this cannot cause the pressing member 18 to produce the pressing force required for pressing the IC device P.

The IC socket 10 further comprises a pair of force application members 106 displaceably provided on the movable base 84 (FIG. 1, FIG. 5). These force application members 106 are disposed respectively along a pair of opposing edges of the center opening 90 near both side plate portion 88 of the movable base 84, and are rotatably attached to the bottom plate portion 86 by shafts 108 extending in parallel to the bottom plate portion 86 of the movable base 84. Each force application member 106 is a member in the shape of S in cross section, and is formed, for example, by punching and bending a sheet metal material in a predetermined shape, and has a first locking hook 110 projecting in the direction toward the center opening 90 at one end spaced from the shaft 108, and has a second locking hook 112 at the other end opposite to the first locking hook 110 projecting in the direction away from the center opening 90.

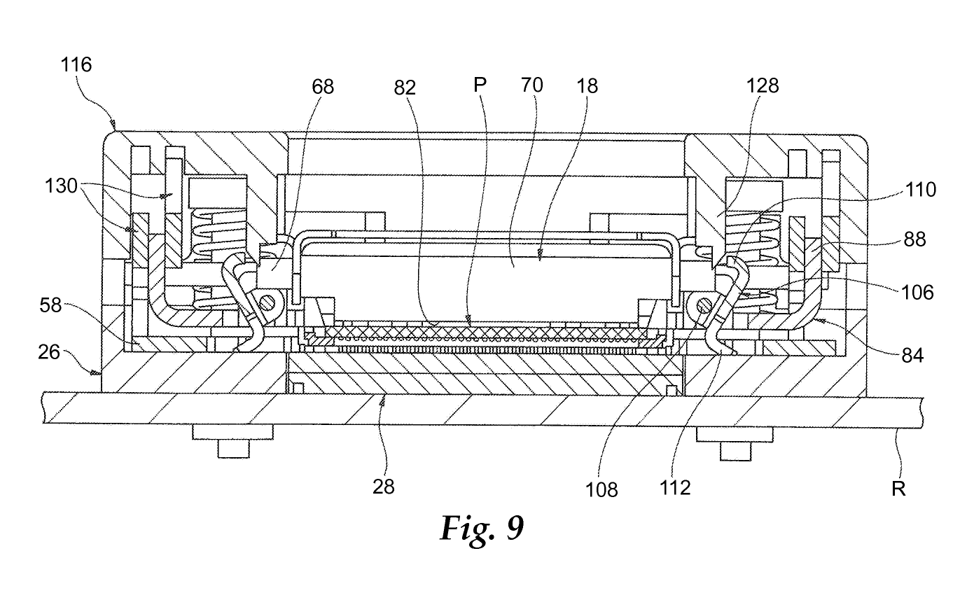

The force application member 106 can be rotated relative to the movable base 84 over a predetermined angular range with a position in which the first locking hook 110 is disposed vertically above the shaft 108 while the second locking hook 112 abuts to the bottom plate portion 86 of the movable base 84 (that is, the locking position to be described later) (FIG. 7), and a position in which the first locking hook 110 is disposed closer to the side plate portion 88 of the movable base 84 than the shaft 108 while the second locking hook 112 leaves the bottom plate portion 86 and is close to the bottom wall 34 of the outer shell member 26 (that is, the release position to be described later) (FIG. 9) as limiting points. An elastic element 114 such as helical torsion coil spring for elastically biasing the force application member 106 toward the locking position is attached to the shaft 108 of each force application member 106 (FIG. 1).

When a pair of pressing members 18 are in the closed position on the movable base 84, each force application member 106, in the locking position, locks both pressing members 18 to the closed position with the first locking hook 110 engaging with that portion of the shaft 68 of the pressing element 70 of both pressing members 18 which projects on the same side on the movable base 84, while, in the release position, the first locking hook 110 disengages from the shaft 68 of the pressing element 70 of both pressing members 18 and can release both pressing members 18. Therefore, when both pressing members 18 are in the closed position on the movable base 84, by disposing both force application members 106 in the locking position, the spring load of four elastic members 20 is applied via the bottom plate portion 86 of the movable base 84 and the first locking hook 110 of both force application members 106 to the shaft 68 of the pressing element 70 of both pressing members 18 as an elastic biasing force in the direction toward the positioning support part 46 of the support guide member 32. A pressing force required for pressing the IC device P is thereby produced in the pressing surface 82 of the pressing element 70 of both pressing members 18. By disposing both force application members 106 in the release position, the biasing force to the shaft 68 of the pressing element 70 of both pressing members 18 is released, so that both pressing members 18 can be freely rotated about the spindle 64 between the closed position and the open position.

An operation member 22 of the IC socket 10 is composed of a cover 116 arranged to be able to move, in translation or parallel displacement in directions toward and away from the housing 14 (FIG. 1). The cover 116 is a frame shaped member fabricated from an electrically insulating material superior in mechanical strength and heat resistance and of a substantially rectangular shape when seen in plan view. The cover 116 integrally comprises a top wall 120 having a center opening 118, and a surrounding wall 122 (FIG. 6). The top wall 120 Of the cover 116 has a substantially flat top surface 120a. A plurality of engagement pieces 124 extending in the direction generally perpendicular to the top surface 120a of the top wall 120 are provided in suitably dispersed manner (FIG. 1). These engagement pieces 124 are complementarily and slidably received in a plurality of grooves 38 (FIG. 2) formed on the circumferential wall 36 of the outer shell member 26 of the housing 14.

The cover 116 is assembled to the housing 14 in a state with a plurality of engagement pieces 124 received in the corresponding grooves 38 of the housing 14. In this state, the cover 116 can be moved under a mutual guiding action of the engagement pieces 124 and the grooves 38, relative to the housing 14 in vertical direction substantially perpendicular to the top surface 120a and back surface 34b while maintaining the top surface 120a of the top wall 120 generally in parallel to the back surface 34b of the bottom wall 34 of the outer shell member 26. It is possible to provide, between the cover 116 and housing 14 on both the engaging piece 124 and the groove 38 forming a desired pair, a shoulder 124a and a catch 38a capable of engaging complementarily with each other, respectively, for preventing the cover 116 from detaching from the housing 14 (FIG. 1). Four through-holes 125 capable of individually receiving head parts 98 of four guide pins 94 fixed to the housing 14 are formed in the top wall 120 of the cover 116 (FIG. 2).

In the state with the cover 116 correctly assembled to the housing 14, the center opening 118 of the cover 116 is arranged at a position surrounding the space 12 of the housing 14 when seen in plan view. In this state, if a pair of pressing members 18 are moved to the open position, it is possible to insert or take out the IC device P to or from the space 12 through the center opening 118 of the cover 116. Operating modes of the two pressing members 18 by the cover 116 will be described later.

On the top wall 120 of the cover 116, four pressing-member actuating elements 126 capable of engaging with a pair of pressing elements 18 are provided on the back surface 120b on the opposite side of the top surface 120a (only one is shown in FIG. 1). Each pressing-member actuating element 126 is a pillar-shaped element integrally provided upright to the back surface 120b of the top wall 120, constructed such that the distal end is capable of abutting to the abutting piece 76 provided on each arm portion 72 of the frame element 66 of each pressing member 18. Thus, while the cover 116 is moved vertically relative to the housing 14, individual pressing-member actuating element 126 is abutted at the distal end by the abutting piece 76 of corresponding pressing member 18, so that, by the torque produced in this manner, individual pressing member 18 can be displaced in rotation about the spindle 64 between the closed position and the open position (FIG. 12).

Two force-application-member actuating elements 128 capable of engaging with a pair of force application member 106 are further provided on the back surface 120b of the top wall 120 of the cover 116 (only one is shown in FIG. 1). Each force-application-member actuating elements 128 is a pillar-shaped element integrally provided upright to the back surface 120b of the top wall 120 separate from the pressing-member actuating element 126, constructed such that the distal end is capable of abutting against the first locking hook 110 of each force application member 106. Thus, while the cover 116 is moved vertically relative to the housing 14, individual force-application-member actuating element 128 abuts at the distal end against the first locking hook 110 of corresponding force application member 106, so that individual force application member 106 can be displaced in rotation about the shaft 108 between the locking position and the release position (FIG. 12).

The IC socket 10 further comprises two sets of force transmission members 130 interposed between the elastic member 20 (four elastic members 20) and the operation member 22 (the cover 116) for reducing the biasing force of the elastic member 20 by leverage action and transmitting it to the operation member 22 (FIG. 1, FIG. 5). Each force transmission member 130 is an elongated plate-shaped member formed, for example, by punching a sheet metal material in a predetermined shape, and comprises a first engagement end 132 for engaging with the housing 14, a second engagement end 134 for engaging with the operation member 22 (the cover 116), a pivot end 136 interconnected to the movable base 84 at a position outside of the first and the second engagement ends 132, 134 and closer to the first engagement end 132 than to the second engagement end 134 (FIG. 5). A bearing hole 138 penetrating in the plate-thickness direction is formed in the pivot end 136 of each force transmission member 130.

The force transmission member 130 is disposed such that the portion including the first engagement end 132 and the pivot end 136 is adjacent to one side plate portion 88 of the movable base 84. The spindle 64 of the pressing member 18 inserted into the bearing hole 102 of the side plate portion 88 of the movable base 84 is further fitted into the bearing hole 138 of the pivot end 136 of the force transmission member 130 (FIG. 5), whereby the force transmission member 130 is rotatably interconnected to the movable base 84 via the spindle 64.

Two sets of force transmission members 130 include one set (two pieces) of force transmission members 130 attached to both ends of the spindle 64 of one pressing member 18, and the other set (two pieces) of force transmission members 130 attached to both ends of the spindle 64 of the other pressing member 18. Each set of force transmission members 130 include a first force transmission members 130 disposed inside one side plate portion 88 of the movable base 84 and a second force transmission members 130 disposed outside the other side plate portion 88 of the movable base 84, such that the first force transmission members 130 of one set and the second force transmission members 130 of the other set are arranged in intersection in the shape of X with each other with the side plate portion 88 of the movable base 84 interposed therebetween (FIG. 5).

Each force transmission member 130 engages slidingly with the reinforcing member 58 fixed to the outer shell member 26 of the housing 14 at the outer edge of the first engagement end 132 on the one hand, and engages slidingly with the back surface 120b of the top wall 120 of the cover 116 at the outer edge of the second engagement end 134 on the other hand (FIG. 11). A slot 140 is formed in the intersecting region of the bottom plate portion 86 and the side plate portion 88 of the movable base 84 for passing the first engagement end 132 of the first force transmission member 130 disposed inside the side plate portion 88 therethrough (FIG. 5).

The force transmission member 130 is formed such that the distance between the first engagement end 132 and the bearing hole 138 of the pivot end 136 (spindle 64) is shorter than the distance between the second engagement end 134 and the bearing hole 138 of the pivot end 136 (spindle 64). Thus, the force transmission member 130 can reduce the force applied to the movable base 84 and the spindle 64 using the first engagement end 132 that slidingly engages with the reinforcing member 58 as a fulcrum, and output it to the cover 116 at the second engagement end 134. Here, the reinforcing member 58 exhibits sufficient durability to the sliding contact under excessive pressure with the first engagement end 132 of individual force transmission member 130.

As a result, in the IC socket 10, while the cover 116 is moved vertically relative to the housing 14, the biasing force due to the spring load of the four elastic members 20 is applied via the movable base 84 and two sets of force transmission members 130 to the cover 116, the cover 116 can be operated with an operating force corresponding to the biasing force of the elastic members 20 reduced by two force transmission members 130. In accordance with such movement of the cover 116, the movable base 84 directly subjected to the spring load of four elastic members 20 moves vertically in translation together with a pair of pressing members 18 relative to the housing 14, and a pair of pressing member 18 is displaced in rotation between the closed position and the open position.

Thus, the IC socket 10 employs the construction in which the biasing force due to the spring load of four elastic members 20 is transmitted, without intermediate assistor such as a lever or a link as in a conventional structure, directly to a pair of pressing member 18 to produce pressing force, while the operating force for operating the cover 116 is reduced by the leverage action of two sets of force transmission members 130. Therefore, with the IC socket 10, the transmission loss of the biasing force of the elastic members 20 that produce the pressing force of the pressing member 18 can be reduced, and the pressing member 18 can be displaced to open/closed position with smaller operating force. Further, even in the case of a large IC device with the number of leads exceeding 1000, elastic members 20 having necessary and sufficient longitudinal elastic coefficient (or, spring constant) to ensure required contact pressure by flexing the built-in elastic elements of corresponding number of contacts 116 can be effectively used.

The IC socket 10 is constructed such that, while the cover 116 is vertically moved in translation relative to the housing 14, the pressing surface 82 of the pressing element 70 of individual pressing member 18 is moved in translation between an operating position (that is, the closed position of the pressing member 18) in which it is positioned nearest to the positioning support part 46 of the support guide member 32, and a first non-operating position (that is, an intermediate position of the pressing member 18) in which it is positioned slightly apart from the positioning support part 46 of the support guide member 32 (FIG. 8, FIG. 9), and is further moved in rocking motion between the first non-operating position and the second non-operating position (that is, the open position of the pressing member 18) in which it is positioned further apart from the positioning support part 46 of the support guide member 32 (FIG. 10, FIG. 11). In case where the IC device P is placed on the support guide member 32, the pressing surface 82 of each pressing member 18 presses the IC device P with the required pressing force at the operating position, is moved in translation from the operating position to the first non-operating position slightly apart from the IC device P, and is further moved in rocking motion from the first non-operating position to the second non-operating position sufficiently apart from the IC device P.

The operation mode of the IC socket 10 including the operation of the pressing surface 82 will be described in further detail below with reference to FIG. 6 to FIG. 12.

First, while the cover 116 is held at the upper-limit position most apart upward from the housing 14 under the elastic biasing force of four elastic members 20 reduced by the leverage action of the force transmitting member 130, a pair of pressing members 18 is placed in the closed position, and the pressing surface 82 of the pressing element 70 is in the operating position nearest to the positioning support part 46 of the support guide member 32 of the housing 14 (FIG. 6, FIG. 12(a)). At this time, a pair of force application members 106 are arranged at the locking position under the biasing action of the elastic element 114 (FIG. 1), and the spring load of four elastic members 20 is applied as elastic biasing force to the shaft 68 of the pressing element 70 of both pressing members 18 via the bottom plate portion 86 of the movable base 84 and the first locking hook 110 of both force application members 106 in the direction toward the positioning support part 46 of the support guide member 32 (FIG. 7, FIG. 12(a)).

Thus, if the IC device P is placed on the support guide member 32, the pressing surface 82 of each pressing member 18 presses the IC device P with required pressing force due to the biasing force of four elastic members 20 (FIG. 7). As a result, each of a plurality of contacts 16 held by the contact holding member 28 is elastically deformed under the pressing force of the corresponding lead Q of the IC device P (FIG. 10), so that individual leads Q and the contact points 16a of the contacts 16 (FIG. 10) abut to each other under a predetermined contact pressure and are electrically connected.

When the cover 116 is pressed from the upper-limit position as described above in the direction toward the housing 14 (arrow a) against the reduced biasing force of the elastic members 20, the movable base 84 moves upward in translation relative to the housing 14 against the spring load of four elastic members 20 (FIG. 8). Until the cover 116 reaches from the upper-limit position described above to the intermediate position incompletely depressed relative to the housing 14, the movable base 84 moves upward from the initial position for a predetermined distance, and accordingly, a pair of pressing member 18 together with the force application member 106 in locking position moves to an intermediate position a predetermined distance apart from the positioning support part 46 of the support guide member 32 (FIG. 9). In the meantime, the pressing surface 82 of the pressing element 70 of each pressing member 18 moves from the operating position to the first non-operating position substantially in translation.

Just before the cover 116 and the pressing member 18 reach the intermediate position, two force-application-member actuating elements 128 abut against the first locking hook 110 of corresponding force application member 106 at the distal end to displace individual force application members 106 in rotation about the shaft 108 from the locking position to the release position against the biasing action of the elastic element 114 (FIG. 1, FIG. 9). Thus, when the cover 116 and the pressing member 18 reach the intermediate position, the biasing force of the elastic member 20 applied to the shaft 68 of the operation member 18 is released, so that the operation member 18 can freely rotate between the closed position and the open position. When the cover 116 and the pressing member 18 reach the intermediate position, four pressing-member actuating elements 126 of the cover are arranged at positions in contact at the tip with the abutting piece 76 of the corresponding pressing member 18 (FIG. 8). At this time, however, force is not applied by the pressing-member actuating elements 126 to the abutting piece 76, and therefore, no torque on the pressing member 18 about the spindle 64 is produced.

During the above-described operation, if the IC device is placed on the support guide member 32, the pressing force from the pressing surface 82 of the pressing member 18 is released, and a plurality of contacts 16 is elastically restored, and the contact pressure of individual leads Q of the IC device P (FIG. 10) and the contact point 16a of corresponding contact 16 (FIG. 10) is released. At this time, the lead Q of the IC device P is securely spaced from the contact point 16a of the contact 16 by the action of the elastic element 56 arranged between the contact holding member 28 and the support guide member 32 (FIG. 1).

When the cover 116 is further depressed from the above-described intermediate position in the direction toward the housing 14 (arrow a) against the reduced biasing force of the elastic member 20, the movable base 84 is further moved upward in translation relative to the housing 14 against the spring load of four elastic member 20 (FIG. 10). Until the cover 116 reaches from the intermediate position to the lower-limit position completely depressed relative to the housing 14, the movable base 84 is moved further upward, and at the same time, four pressing-member actuating elements 126 of the cover 116 abut at the distal end against the abutting pieces 76 of corresponding pressing member 18 to apply a force corresponding to the cover operating force. As a result, in accordance with further upward movement of the movable base 84, a torque about the spindle 64 is produced on each of a pair of pressing members 18, and each pressing member 18 is displaced in rotation against the biasing action of the elastic element 104 (FIG. 5) to the open position further apart from the positioning support part 46 of the support guide member 32. The pressing surface 82 of the pressing element 70 of each pressing member 18 is thereby displaced in rocking motion from the first non-operating position to the second non-operating position (FIG. 11, FIG. 12(b)).

Thus, in the state with the cover 116 reaching the lower-limit position, a pair of pressing members 18 are placed in the open position to open the upper space above the support guide member 32 widely, so that the IC device P can be accurately inserted or taken out to or from the positioning support part 46 of the support guide member 32 through the center opening 118 of the cover 116.

When, in using the IC socket 10, an IC device P is to be mounted to the empty IC socket 10, to the IC socket 10 mounted to a circuit board R (FIG. 8), in the state with a pair of pressing member 18 arranged in the open position (FIG. 10) (that is, with the cover 116 depressed to the lower-limit position relative to the housing 14), the IC device P is loaded onto the positioning support part 46 of the support guide member 32 of the housing 14 through the center opening 118 of the cover 116. Then, by releasing the operating force on the cover 116, the cover 116 is moved in translation in the direction away from the housing 14, and four pressing-member actuating elements 126 of the cover disengage from the abutting piece 76 of corresponding pressing member 18. As a result, each pressing member 18 is automatically rotated toward the closed position by the biasing action of the elastic element 104, and the pressing surface 82 is displaced in rocking motion from the second non-operating position to the first non-operating position.

As the operating force on the cover 116 continues to be released, the movable base 84 together with a pair of pressing members 18 moves downward in translation in the direction toward the reinforcing member 58 fixed to the housing 14. While the cover 116 is being moved from the intermediate position to the upper-limit position, two force-application-member actuating elements 128 disengage from the first locking hook 110 of corresponding force application member 106, and a pair of force application members 106 are arranged in the locking position by the biasing action of the elastic element 114, and in this state, the pressing surface 82 of each pressing member 18 moves in translation from the first non-operating position to the operating position. When the pressing surface 82 of individual pressing member 18 reaches the operating position, a pair of force application members 106 in the locking position apply the biasing force of the elastic member 20 to the shaft 68 of the pressing element 70 of both pressing members 18 via the first locking hook 110. Required pressing force is thereby applied by the pressing surface 82 of each pressing member 18, so that a plurality of contacts 16 and a plurality of leads Q of the IC device P abut to each other under a predetermined contact pressure and are electrically connected.

The present invention has been described above with reference to preferred embodiments thereof. It is to be understood, however, that the construction of an IC socket according to the present invention is not limited to the above-described embodiments, but various modification can be made, especially as regards shape, number, arrangement, etc., of the constituents.

1. An IC socket comprising:
a housing detachably containing an IC device;
a plurality of contacts provided respectively with contact points disposed inside the housing in an elastically displaceable manner;
a pressing member pressing the IC device contained in the housing and making a plurality of leads of the IC device abut against the contact points of the plurality of contacts;
an elastic member elastically biasing the pressing member and making the pressing member generate a pressing force for pressing the IC device; and
an operation member adapted to be moved relative to the housing against the biasing force of the elastic member and to displace the pressing member between a closed position for generating the pressing force and an open position spaced from the closed position;
characterized in that said IC socket comprises a force transmission member interposed between said elastic member and said operation member, said force transmission member transmitting the biasing force of said elastic member to said operation member with the biasing force being reduced by a leverage action; and that
said pressing member is adapted to accompany a movement of said operation member relative to said housing under an operating force corresponding to said biasing force of said elastic member reduced by said force transmission member, and thus to be displaced between said closed position and said open position.

2. An IC socket according to claim 1, further comprising a movable base attached to said housing in a linearly movable manner and rotatably carrying said pressing member, wherein said elastic member is disposed between said housing and said movable base and biasing said movable base in a direction toward said housing, and wherein said biasing force of said elastic member is applied via said movable base to said pressing member.

3. An IC socket according to claim 2, wherein said force transmission member includes a first engagement end engaging with said housing, a second engagement end engaging with said operation member, and a pivot end joined to said movable base at a position outside said first engagement end and said second engagement end and closer to said first engagement end, not to said second engagement end.

4. An IC socket according to claim 2, further comprising a force application member provided on said movable base in a displaceable manner, said force application member applying said biasing force of said elastic member to said pressing member and locking said pressing member to said closed position.

5. An IC socket according to claim 4, further comprising a force-application-member actuating element provided in said operation member, said force-application-member actuating element engaging with said force application member during a moving operation of said operation member relative to said housing and displacing said force application member between a locking position where said pressing member is locked in said closed position and a release position where said pressing member is released.

6. An IC socket according to claim 1, further comprising a pressing-member actuating element provided in said operation member, said pressing-member actuating element engaging with said pressing member during a moving operation of said operation member relative to said housing and displacing said pressing member between said closed position and said open position.
